(19) United States
(12) Patent Application Publication
(10) Pub. No.: US 2013/0318206 A1
(43) Pub. Date: Nov. 28, 2013

(54) RENDER, CONTROLLER AND MANAGING METHODS THEREOF

(71) Applicant: GEMTEK TECHNOLOGY CO., LTD., Hsinchu (TW)

(72) Inventor: Ju-Hung Hsiao, Tainan City (TW)

(73) Assignee: GEMTEK TECHNOLOGY CO., LTD., Hsinchu (TW)

(21) Appl. No.: 13/707,557

(22) Filed: Dec. 6, 2012

(30) Foreign Application Priority Data
May 28, 2012 (TW) 101118972

(51) Int. Cl. H04L 29/08

(52) U.S. Cl. CPC H04L 67/32
USPC 709/219

(57) ABSTRACT

A render, a controller, and managing methods thereof are provided. The render includes a storage unit, a playback unit, and a determination unit. The storage unit includes an instruction queue temporarily saving an instruction from the controller. According to a playback instruction from the controller, the playback unit downloads a multimedia file from a server through a network and plays the multimedia file. The determination unit receives the instruction through the network and determines whether a first controller identification information is identical to a second controller identification information corresponding to the multimedia currently played by the render. When the first controller identification information is identical to the second controller identification information, the render performs an operative action corresponding to the instruction. When the first controller identification information is different from the second controller identification information, the instruction is saved in the instruction queue of the storage unit.

### CROSS-REFERENCE TO RELATED APPLICATION

This application claims the priority benefit of Taiwan application serial no. 101118972, filed on May 28, 2012. The entirety of the above-mentioned patent application is hereby incorporated by reference herein and made a part of this specification.

### TECHNICAL FIELD

The disclosure relates to a managing method of digital media render, and particularly relates to a render, a controller, a managing method of the controller, a managing method of the render applicable under the Digital Living Network Alliance.

### BACKGROUND

Digital Living Network Alliance (DLNA) is an industrial standard set up by a plurality of manufacturers, which is based on the technology of Universal Plug and Play (UPnP), and integrates multimedia contents to simply share multimedia files, such as pictures, music, videos, and playlists.

Devices applicable under DLNA can be divided into digital media servers (DMS), digital media renders (DMR), and digital media controllers (DMC). A digital media controller may explore multimedia files saved in a digital media server, send an instruction to a digital media render, controls the digital media render to download multimedia files from the digital media server and to play the multimedia files. The above-mentioned devices communicate via a shared language and channel, so video and audio data can be shared without additionally installing a driver or using a specific wire.

In the current definition of DLNA, a control instruction of the digital media controller to the digital media render is implemented with fully open authorization. Namely, as long as the media controller can connect to the digital media render within an accessible range, the media controller can control the digital media render to execute actions such as playback or pause with fully open authorization. Therefore, if there are a plurality of digital media controllers capable of controlling one digital media render in a local area network, alternative control may occur since each of the plurality of digital media controllers has the control right to the digital media render.

### SUMMARY

In view of the above, the disclosure provides a render and a managing method thereof. By determining a controller identification information of a received instruction, it is determined whether a corresponding operative action is performed. Thereby, the issue of controlling the render alternatively is avoided.

The disclosure provides a controller and a managing method thereof, which sends an instruction having controller identification information to obtain a control right of the render.

Viewing from one aspect, the disclosure provides a render, including a storage unit, a playback unit, and a determination unit. The storage unit includes an instruction queue configured for temporarily saving at least one instruction from the controller. The playback unit is connected to the storage unit, and downloads multimedia files from a server through a network and plays one of the multimedia files according to a playback instruction of the controller. The determination unit is connected to the storage unit, respectively receives at least one instruction through the network, and determines whether a first controller identification information of each instruction is identical to a second controller identification information corresponding to the multimedia file currently played. When the first controller identification information is identical to the second controller identification information, the render executes a corresponding operative action of the instruction. When the first controller identification information is different from the second controller identification information, the instruction is saved in the instruction queue of the storage unit.

In an embodiment of the disclosure, when the determination unit determines that the first controller identification information of an instruction is identical to the second controller identification information corresponding to the multimedia file currently played, a first controller that generates the instruction has the control right of the render.

In an embodiment of the disclosure, if the determination unit determines that the first controller identification information of an instruction is different from the second controller identification information corresponding to the multimedia file currently played, the first controller that generates this instruction does not have the control right of the render.

In an embodiment of the disclosure, the storage unit further includes a multimedia queue temporarily saves a multimedia file downloaded from the server, wherein when each time the storage unit temporarily saves a multimedia file, the storage unit makes the multimedia file correspond to a controller identification information of a controller selecting the multimedia file.

In an embodiment of the disclosure, if the first controller has the control right, and when all multimedia files corresponding to the first controller identification information of the first controller in the multimedia queue are played, the render transfers the control right to a second controller and executes sequentially at least one instruction having a third controller identification information of the second controller in the instruction queue.

In an embodiment of the disclosure, operative actions corresponding to the instruction include an action of playing, an action of pausing, an action of forwarding, and action of rewinding, an action of skipping the current multimedia file, and an action of adjusting volume.

In an embodiment of the disclosure, when the render receives a request information from the second controller, the determination unit compares a first authorization level of the first controller that has the control right and a second authorization level of the second controller, wherein when the determination unit determines that the second authorization level is higher than the first authorization level, the render transfers the control right to the second controller, and executes at least one instruction corresponding to the second controller in the instruction queue first.

In an embodiment of the disclosure, the request information includes a request information of control right and a request information of cleaning up instruction queue. When the render receives the request information of cleaning up instruction queue, the storage unit cleans up all instructions corresponding to the first controller in the instruction queue and transfers the control right to the second controller.

In an embodiment of the disclosure, when the render receives the request information of control right having a first code from the second controller, the render compares to see if the first code is identical to a preset second code. When the first code is identical to the second code, the render transfers the control right to the second controller.

Viewing from another aspect, the disclosure provides a managing method of render that includes the followings. First, an instruction is temporarily saved from a controller. Then, according to a playback instruction of the controller, multimedia files are downloaded from a server through a network and one of the multimedia files is played. Also, instructions are received through the network and whether a first controller identification information of each instruction is identical to a second identification information corresponding to the multimedia file currently played is determined. Moreover, an operative action corresponding to the instruction is executed when the first controller identification information is identical to the second controller identification information, whereas the instruction is saved in an instruction queue when the first controller identification information is different from the second controller identification information.

In an embodiment of the disclosure, when it is determined that the first controller identification information of the instruction is identical to the second controller identification information corresponding to the multimedia file currently played, a first controller generating the instruction has a control right of the render.

In an embodiment of the disclosure, when it is determined that the first controller identification information is different from the second controller identification information corresponding to the multimedia file currently played, the first controller generating the instruction does not have the control right of the render.

In an embodiment of the disclosure, the managing method of render further includes temporarily saving the multimedia files downloaded from the server, wherein when each time a multimedia file is temporarily saved, the multimedia file is made correspond to a controller identification information of a controller selecting the multimedia file.

In an embodiment of the disclosure, wherein when the first controller has the control right, and when all multimedia files corresponding to the first controller identification information of the first controller in the multimedia queue are played, the control right is transferred to a second controller, and instructions that have a third controller identification information of the second controller is executed sequentially.

In an embodiment of the disclosure, wherein operative actions corresponding to the instruction include an action of playing, an action of pausing, an action of forwarding, an action of rewinding, an action of skipping the current multimedia file, and an action of adjusting volume.

In an embodiment of the disclosure, the managing method of render includes when a request information sent from the second controller is received, comparing a first authorization level of the first controller that currently has the control right and a second authorization level of the second controller. When it is determined that the second authorization level of the second controller is higher than the first authorization level, the control right is transferred to the second controller, and instructions corresponding to the second controller having the control right in the instruction queue are executed first.

In an embodiment of the disclosure, the request information includes a request information of control right and a request information of cleaning up instruction queue, wherein when the request information of cleaning up instruction queue is received, all instructions corresponding to the first controller in the instruction queue are cleaned up, and the control right is transferred to the second controller.

In an embodiment of the disclosure, the managing method of render includes when the request information of control right having a first code sent from the second controller is received, comparing whether the first code is identical to a preset second code. When the first code is identical to the preset second code, the control right is transferred to the second controller.

The disclosure provides a controller including a generation unit and a request unit. The generation unit generates an instruction, and the instruction has a controller identification information of the controller. The request unit is connected to the generation unit, and sends a request information to a render when the controller does not have a control right of the render, so as to request the control right of the render, wherein the request information includes the controller identification information.

In an embodiment of the disclosure, the request unit sends a request information of cleaning up instruction queue to request for cleaning up all instructions corresponding to another controller that has the control right in an instruction queue of the render.

In an embodiment of the disclosure, the request unit sends the request information having a first code. If the first code is identical to a preset second code, the control right of the render is obtained.

Viewing from still another viewpoint, the disclosure provides a managing method of controller adapted for a controller to control a render. The managing method of controller includes generating an instruction that has a controller identification information of the controller, and when the controller does not have a control right of the render, sending a request information to the render to request the control right of the render, wherein the request information also includes the controller identification information.

In an embodiment of the disclosure, the step of sending the request information to the render includes sending a request information of cleaning up instruction queue to request for cleaning up all instructions corresponding to another controller having the control right in the instruction queue of the render.

In an embodiment of the disclosure, the step of sending the request information to the render includes sending the request information with a first code. In addition, when the first code is identical to a preset second code, the controller obtains the control right of the render.

Based on the above, a render, a controller, and managing methods thereof provided in the disclosure determine which instruction is generated by which controller by adding a corresponding controller identification information to an instruction when the controller sends the instruction, and further develop a concept of control right to avoid the issue of controlling the render alternatively.

In order to make the aforementioned and other features and advantages of the invention more comprehensible, embodiments accompanying figures are described in detail below.

### BRIEF DESCRIPTION OF THE DRAWINGS

The accompanying drawings are included to provide further understanding, and are incorporated in and constitute a part of this specification. The drawings illustrate exemplary embodiments and, together with the description, serve to explain the principles of the disclosure.

FIG. 1 is a block diagram of a render according to an embodiment of the disclosure.

FIG. 2 is a flow chart of a managing method of render according to an embodiment of the disclosure.

FIG. 3 is a block diagram of a controller according to an embodiment of the disclosure.

FIG. 4 is a flow chart of a managing method of controller according to an embodiment of the disclosure.

FIG. 5 is a schematic diagram of a digital media system according to another embodiment of the disclosure.

FIG. 6 is a schematic diagram of a render according to another embodiment of the disclosure.

FIG. 7 is a schematic diagram of logical concept of a multimedia queue according to another embodiment of the disclosure.

FIG. 8 is an example of an instruction of transferring control right according to still another embodiment of the disclosure.

### DETAILED DESCRIPTION OF DISCLOSED EMBODIMENTS

Various manufacturers have been providing products with a function of digital media controller as digital home becomes continuously popularized. In a network of digital home, there may be a plurality of digital media controllers. Therefore, how to avoid the problem that a plurality of digital media controllers control the same digital media render in the same local area network, which results in alternative control, is indeed an important issue. In view of the above, the disclosure provides a controller, a render, and a managing method thereof. In order to make the disclosure more comprehensible, embodiments are described below as examples showing that the disclosure can actually be realized. The embodiments provided herein are only for an illustrative purpose, instead of limiting the scope of the disclosure.

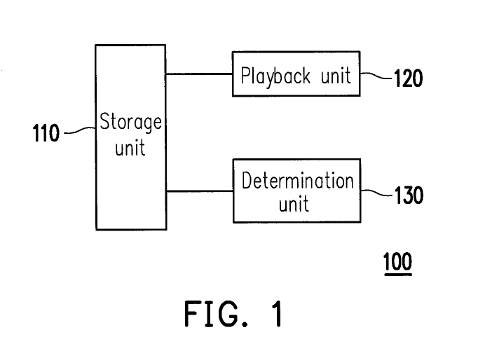

FIG. 1 is a block diagram of a render according to an embodiment of the disclosure. Referring to FIG. 1, a render 100 of this embodiment is, for example, a digital media render that conforms to the standard of Digital Living Network Alliance (DLNA). The render 100 includes a storage unit 110, a playback unit 120, and a determination unit 130. The function of each unit is described below.

The storage unit 110 includes any kind of fixed or portable random access memory (RAM), read only memory (ROM), flash memory, hard disk, or the like. The storage unit 110 may be configured for saving an instruction queue, and the instruction queue is configured for temporarily saving an instruction from a controller. The controller is, for example, a digital media controller that conforms to the standard of DLNA.

The playback unit 120 is connected to the storage unit 110 and includes a display unit, such as a liquid crystal display (LCD), light emitting diode (LED), or other kinds of display unit. The playback unit 120 may be used to download and play multimedia files that include picture, audio, and video files.

The determination unit 130 is connected to the storage unit 110, receives at least one instruction sent by at least one controller through a network (not shown), and determines whether a controller identification information of each instruction is identical to a controller identification information corresponding to a multimedia file currently played by the render 100. Afterward, the render 100 performs different operations according to a result of determination of the determination unit 130.

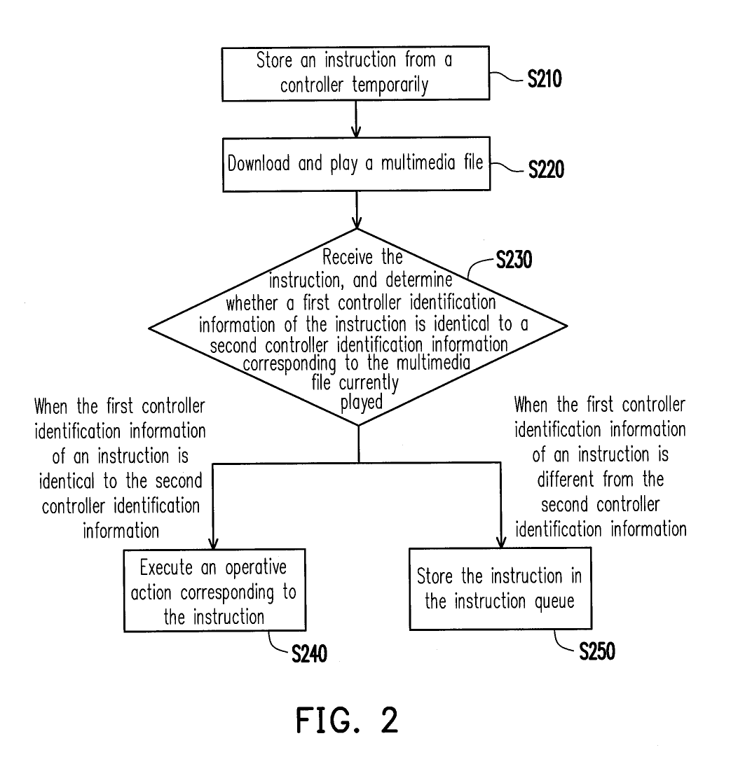

FIG. 2 is a flowchart illustrating a managing method of render according to an embodiment of the disclosure. Referring to FIG. 2, the method of this embodiment is suitable for the render 100 illustrated in FIG. 1. In the following, each unit of FIG. 1 is accompanied with detailed description of the managing method of the render according to the embodiment of the disclosure.

First, the storage unit 110 may temporarily save the at least one instruction from the at least one controller in the instruction queue (Step S210), wherein any one of the controller may send at least one instruction. Afterward, if the at least one instruction includes one or more playback instructions, the playback unit 120 follows the one or more playback instructions to download one or more multimedia files from a digital media server (not shown) through the network and play one of the multimedia files (Step S220). The server is, for example, a multimedia server that conforms to the standard of DLNA.

The determination unit 130 further respectively receives the one or more instructions sent from each of the at least one controller through the network, and respectively determines whether a first controller identification information of each instruction is identical to a second controller identification information corresponding to the multimedia file currently played (Step S230). Afterward, when the determination unit 130 determines that the first controller identification information of an instruction is identical to the second controller identification information, the render 100 performs an operative action corresponding to the instruction received (Step S240). The operative action described herein includes actions such as play, pause, forward, rewind, skip the current multimedia file, or volume adjustment. On the contrary, when the determination unit 130 determines that the first controller identification information of an instruction is different from the second controller identification information, the render 100 saves the instruction in the instruction queue of the first storage unit 110 (Step S250).

More specifically, the disclosure utilizes the at least one instruction sent by each of the at least one controller that corresponds to a controller identification information. The controller identification information may include information such as a controller identification code, a number of network card of a controller, or the like. Since any information that may be configured for distinguishing between different controllers may be used as the controller identification information of the disclosure, the information is not limited to the above. For example, it may be set that any instruction sent by a controller A has an identification code exclusive to the controller A, whereas any instruction sent by a controller B has an identification code exclusive to the controller B. Therefore, under a circumstance that the render 100 is playing a multimedia file while an instruction is simultaneously received from a controller, the determination unit 130 of the render 100 determines whether the first controller identification information of the instruction is identical to the second controller identification information corresponding to the multimedia file currently played.

If the first controller identification information of the instruction is identical to the second controller identification information corresponding to the multimedia file currently played, it indicates that the controller previously selecting to play the multimedia file is identical to the controller that corresponds to the instruction currently received. Consequently, the determination unit 130 may determine that the controller generating this instruction has the control right of the render 100. Namely, the render 100 performs a corresponding operative action whenever an instruction from the controller is received. On the contrary, if the first controller identification information of the instruction is different from the second identification information corresponding to the multimedia file, it indicates that the controller previously selecting to play the multimedia file is different from the controller that corresponds to the instruction currently received. Therefore, the determination unit 130 determines that the controller generating the instruction does not have the control right of the render 100.

Simply put, in this embodiment, the render 100 determines that the controller previously selecting to play the multimedia file has the control right. Therefore, the render 100 does not immediately perform an instruction from a different controller, but temporarily saves the instruction from the different controller in the instruction queue of the storage unit 110. In this way, the circumstance in which different controllers control the same render 100 is avoided. Thereby, the issue of alternative control is solved.

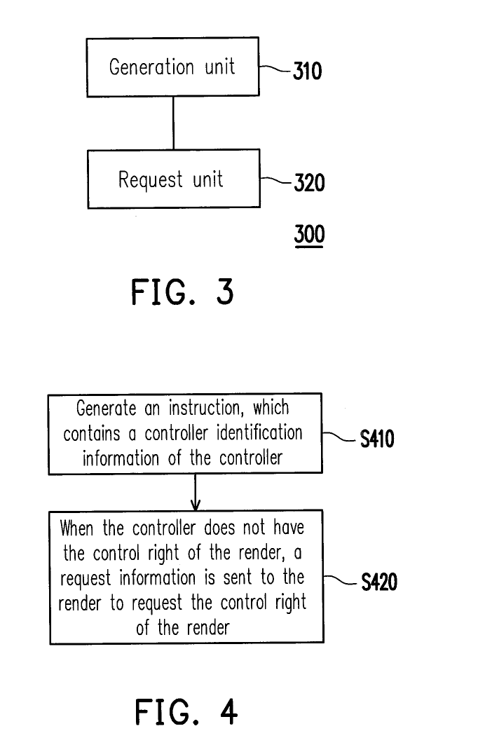

Since each instruction is required to have a controller identification information, the render 100 can determine whether the source controllers that generate instructions are identical or not. Therefore, the disclosure further provides a corresponding controller and a managing method of the controller. Technical details of the controller and processes of the managing method of the controller are described in details hereinafter with reference to FIGS. 3 and 4.

FIG. 3 is a block diagram of a controller according to an embodiment of the disclosure. FIG. 4 is a flowchart of a managing method of controller according to an embodiment of the disclosure.

A controller 300 includes a generation unit 310 and a request unit 320. The generation unit 310 generates an instruction, which contains a controller identification information of the controller 300 (Step S410). If the controller 300 has the control right of a render (e.g. the render 100 of FIG. 1), the render 100 directly executes an operative action that the controller 300 instructs to execute, such as play, pause, and volume adjustment mentioned above. However, if the controller identification information of the controller 300 is not identical to a controller identification information corresponding to a multimedia file currently played by the render 100 after the render 100 compares, then the controller 300 does not have the control right of the render 100. At this time, the controller 300 has to request the control right of the render 100 through a request information sent by the request unit 320 to request the control right of the render 100, wherein the request information also includes the controller identification information (Step S420).

The disclosure provides a method of adding controller identification information to an instruction, such that the render is able to tell which received instruction is sent from which controller, so as to further determine which controller has the control right. Thereby, alternative control may be avoided. However, another embodiment is described in detail below to describe in detail how a controller without control right obtains the control right and under what circumstance may the control right be transferred to another controller.

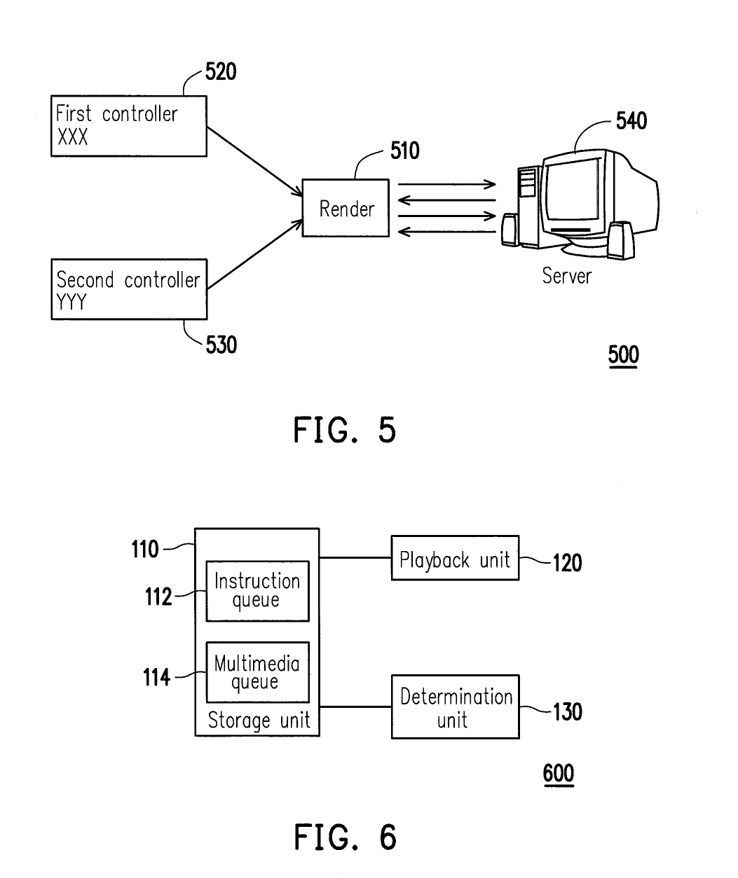

FIG. 5 is a schematic diagram of a digital media system according to another embodiment of the disclosure. FIG. 6 is a schematic diagram of a render according to another embodiment of the disclosure. Referring simultaneously to FIGS. 5 and 6, a digital media system 500 includes a render 510, a first controller 520, a second controller 530, and a server 540. The server 540 is, for example, a computer or the like that is capable of saving one or more multimedia files. The first controller 520 and the second controller 530 are, for example, the controller 300 illustrated in FIG. 3. The render 510 is, for example, the render 100 illustrated in FIG. 1 or a render 600 illustrated in FIG. 6. The render 600 is similar to the render 100 illustrated in FIG. 1, both of which have a storage unit, a playback unit, and a determination unit, but differ from each other in that in addition to an instruction queue 112, the storage unit 110 of the render 600 further includes a multimedia queue 114, which is configured for saving information relevant to a multimedia file, such as a link to the multimedia file.

First, in this embodiment, it is assumed that a controller identification information of the first controller 520 is XXX, whereas a controller identification information of the second controller 530 is YYY. It is also assumed that the first controller 520 and the second controller 530 respectively send a plurality of instructions to play a plurality of different multimedia files. In addition, the plurality of instructions are sent in an alternating temporal order.

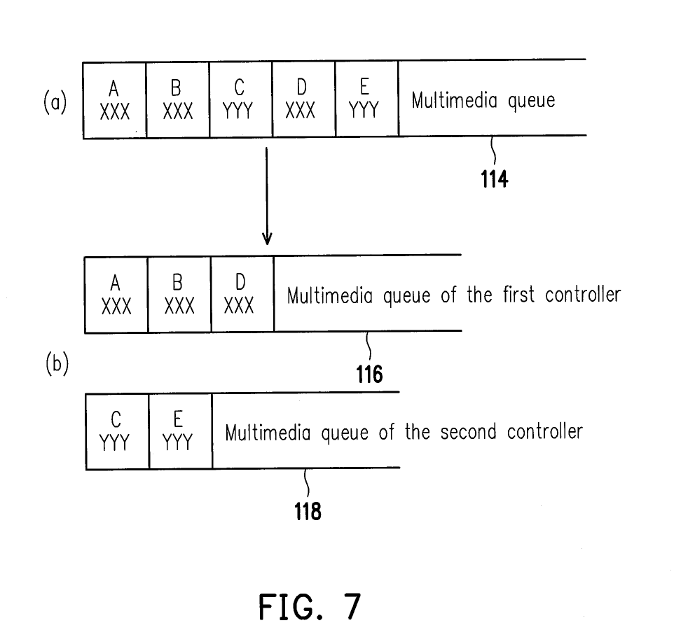

FIG. 7 is a schematic diagram of logical concept of a multimedia queue according to another embodiment of the disclosure. In the disclosure, the storage unit 110 temporarily saves a plurality of multimedia files into the multimedia queue 114, wherein the multimedia files are downloaded from the server 540, and the multimedia files A-E respectively correspond to the controller identification information XXX or YYY. Therefore, as shown in FIG. 7(a), the determination unit 130 is capable of telling that the first controller 520 sends instructions of playing the multimedia files A, B, and D, and thus the multimedia files A, B, and D have the controller identification information XXX of the first controller 520. Similarly, the second controller 530 sends instructions of playing the multimedia files C and E, and thus the multimedia files C and E have the controller identification information YYY of the second controller 530. However, the disclosure is not limited to the above description. In other embodiments, the storage unit 110 may further correspond to playback instructions sent from more than two controllers, wherein a plurality of multimedia files downloaded from a plurality of servers are temporarily saved in the multimedia queue 114.

According to the current standard of DLNA, a render DMR plays the multimedia file A first, then the multimedia file B, and so on. Therefore, for viewers operating with the first controller 520 and the second controller 530, they originally watch the multimedia file played by the render DMR which is originally selected by the first controller 520, but watch the next multimedia file which may be selected by the second controller 530. The viewing mood of the viewers is hence influenced. Consequently, the disclosure provides a method of adding controller identification information, and uses a logical concept to distinguish between multimedia files corresponding to different controller identification information, and save the multimedia files in different logical multimedia queues. As shown in FIG. 7, the multimedia queue 114 prepares different multimedia queues for different controllers. For example, the multimedia files A, B, and D corresponding to the controller identification information of XXX are logically temporarily saved in a multimedia queue 116 of the first controller 520, whereas the multimedia files C and E corresponding to the controller identification information of YYY are logically temporarily saved in a multimedia queue 118 of the second controller 530.

Referring to FIG. 7, it is assumed that currently, there are only two controllers, the controller 520 and the controller 530, that control the render 510, and the first controller 520 has the control right of the render 510. It is also assumed that the render 510 is playing the multimedia file B. If an instruction of skipping to the previous multimedia file is received from the first controller 520, the render 510 stops playing the multimedia file B to play the multimedia file A. If the render 510 is playing the multimedia file B and receives an instruction of skipping to the next multimedia file from the first controller 520, the render 510 stops playing the multimedia file B to play the multimedia file D, instead of playing the multimedia file C. Since the first controller 520 has the control right of the render 510, the render 510 logically finds the previous or next file to be played from the multimedia queue 116 of the first controller 520. After the render 510 finishes playing the multimedia files A, B, and D in the multimedia queue 116 of the first controller 520, the render 510 transfers the control right to the second controller 530 to sequentially play the multimedia files C and E.

In still another embodiment, referring to FIGS. 5 and 6, if the second controller 530 does not want to wait until the multimedia files of the first controller 520 having the control right are finished playing to obtain the control right, the second controller 530 may send an request information to the render 510 to request the control right of the render 510, wherein the request information also includes the controller identification information. Correspondingly, when the render 510 receives the request information from the second controller 530, the render 510 compares a first authorization level of the first controller 520 having the control right with a second authorization level of the second controller 530. When the determination unit 130 determines that the second authorization level is higher than the first authorization level, the render 510 transfers the control right to the second controller 530 and execute at least one instruction corresponding to the second controller 530 in the instruction queue 112 first.

It should be noted that an authorization level of each controller may be configured beforehand by the users or may be determined by a preset authorization level of a controller. The disclosure does not impose any limitation herein. In an embodiment, the request information further includes a request information of cleaning up instruction queue in addition to the request information of control right. When the render 510 receives the request information of cleaning up instruction queue, the storage unit 110 cleans up all of the instructions corresponding to the first controller 520 in the instruction queue 112 and transfers the control right to the second controller 530.

Another embodiment is provided herein for an illustrative purpose. If the render 510 receives the request information of control right having a first code sent by the second controller 530, the render 510 compares the first code with a second code preset in the render 510 to see if the first code is identical to the second code. When the first code and the second code are identical, the render 510 immediately transfers the control right to the second controller 530. An example using extensible markup language (XML) is illustrated below to describe the instruction of transferring control right.

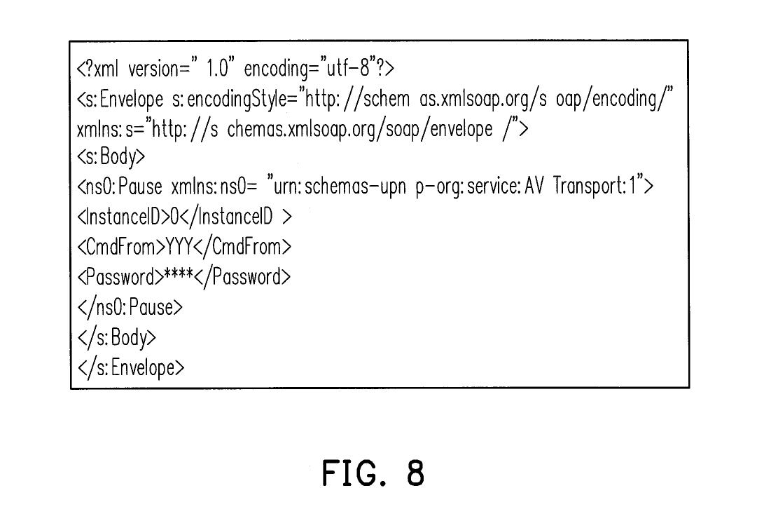

FIG. 8 is an example of an instruction of transferring control right according to still another embodiment of the disclosure. Referring FIGS. 5 and 8 together, this example assumes that the first controller 520 currently has the control right of the render 510, and the render 510 receives an instruction from the second controller 530. In this example, an instruction source field (i.e. CmdFrom) represents controller identification information corresponding to a controller sending the instruction. In this embodiment, the instruction source field is the controller identification information YYY corresponding to the second controller 530. Consequently, if the first code entered by the second controller 530 in a password field (i.e. Password) is identical to the second code preset in the render 510, the render transfers the control right to the second controller 530 and immediately executes this instruction. By considering an instruction field (i.e. ns0:Pause), it is known that the instruction is to stop playing a multimedia file.

Based on the above, the render, controller and the managing methods thereof provided in the disclosure utilize the exclusive controller identification information added to the instructions sent by the controllers, such that the render is able to tell which instruction is generated by which controller. Thereby, the controller owning the control right is determined. In addition, the instruction queue is configured for saving all instructions to avoid alternative control. Moreover, multimedia files are downloaded according to the playback instruction, and multimedia files not played or operated yet is temporarily saved in the multimedia queue, such that the corresponding multimedia file may be immediately played after the control right is transferred. In this way, the viewers spend less time waiting for downloading. Furthermore, the comparison of authorization levels and use of code extended from the controller identification information allow a more complete controlling function of the DLNA system.

Although the disclosure has been described with reference to the above embodiments, it will be apparent to people having ordinary skill in the art that modifications to the described embodiment may be made without departing from the spirit of the disclosure. Accordingly, the scope of the disclosure will be defined by the attached claims not by the above detailed descriptions.

What is claimed is:

1. A render, comprising:
a storage unit, comprising an instruction queue, temporarily saving at least one instruction from at least one controller;
a playback unit, connected to the storage unit, downloading at least one multimedia file from a server through a network, and playing one of the multimedia file according to the at least one instruction from the at least one controller; and
a determination unit, connected to the storage unit, respectively receiving the at least one instruction through the network, and determining whether a first controller identification information of each instruction is identical to a second controller identification information corresponding to the multimedia file currently played by the render, wherein
when the first controller identification information is identical to the second controller identification information, the render executes an operative action corresponding to the instruction; and
when the first controller identification information is different from the second controller identification information, the instruction is saved in the instruction queue of the storage unit.

2. The render as claimed in claim 1, wherein when the determination unit determines that the first controller identification information of the instruction is identical to the second controller identification information corresponding to the multimedia file currently played, a first controller generating the instruction has a control right of the render.

3. The render as claimed in claim 2, wherein if the determination unit determines that the first controller identification information of the instruction is different from the second controller identification information corresponding to the multimedia file currently played, the first controller generating the instruction does not have the control right of the render.

4. The render as claimed in claim 2, wherein the storage unit further comprises:
a multimedia queue, temporarily saving the at least one multimedia file downloaded from the server, wherein when each time the storage unit temporarily saves a multimedia file, the storage unit makes the multimedia file correspond to a controller identification information of a controller selecting the multimedia file.

5. The render as claimed in claim 4, wherein if the first controller has the control right, and when all multimedia files corresponding to the first controller identification information of the first controller in the multimedia queue are played, the render transfers the control right to a second controller, and the render sequentially executes at least one instruction having a third controller identification information of the second controller in the instruction queue.

6. The render as claimed in claim 5, wherein the operative action corresponding to the instruction comprises an action of playing, an action of pausing, an action of forwarding, an action of rewinding, an action of skipping current multimedia file, or an action of adjusting volume.

7. The render as claimed in claim 3, wherein when the render receives a request information from a second controller, the determination unit compares a first authorization level of the first controller having the control right with a second authorization level of the second controller, wherein when the determination unit determines that the second authorization level is higher than the first authorization level, the render transfers the control right to the second controller, and executes at least one instruction corresponding to the second controller in the instruction queue first.

8. The render as claimed in claim 7, wherein the request information comprises a request information of control right and a request information of cleaning up instruction queue, wherein when the render receives the request information of cleaning up instruction queue, the storage unit cleans up all instructions corresponding to the first controller in the instruction queue and transfers the control right to the second controller.

9. The render as claimed in claim 8, wherein when the render receives the request information of control right having a first code from the second controller, the render compares to see whether the first code is identical to a preset second code, wherein when the first code is identical to the second code, the render transfers the control right to the second controller.

10. A managing method of render, comprising:
temporarily saving at least one instruction from at least one controller;
downloading at least one multimedia file from a server through a network and playing one of the multimedia file according to the at least one instruction from the at least one controller;
respectively receiving the at least one instruction through the network and determining whether a first controller identification information of each instruction is identical to a second controller identification information corresponding to the multimedia file currently played;
when the first controller identification information is identical to the second controller identification information, executing an operative action corresponding to the instruction; and
when the first controller identification information is different from the second controller identification information, saving the instruction in an instruction queue.

11. The managing method of render as claimed in claim 10, wherein when it is determined that the first controller identification information of the instruction is identical to the second controller identification information corresponding to the multimedia file currently played, a first controller generating the instruction has a control right of the render.

12. The managing method of render as claimed in claim 11, wherein when it is determined that the first controller identification information of the instruction is different from the second controller identification information corresponding to the multimedia file currently played, the first controller generating the instruction does not have the control right of the render.

13. The managing method of render as claimed in claim 11, further comprises:
temporarily saving the at least one multimedia file downloaded from the server, wherein when each time a multimedia file is temporarily saved, making the multimedia file correspond to a controller identification information of a controller selecting the multimedia file.

14. The managing method of render as claimed in claim 13, wherein if the first controller has the control right, and when all multimedia files corresponding to the first controller identification information of the first controller in the multimedia queue are played, transferring the control right to a second controller, and sequentially executing at least one instruction having a third controller identification information of the second controller in the instruction queue.

15. The managing method of render as claimed in claim 14, wherein the operative action corresponding to the instruction comprises an action of playing, an action of pausing, an action of forwarding, an action of rewinding, an action of skipping current multimedia file, or an action of adjusting volume.

16. The managing method of render as claimed in claim 11, comprising:
when a request information sent from a second controller is received, comparing a first authorization level of the first controller having the control right currently and a second authorization level of the second controller; and
when it is determined that the second authorization level of the second controller is higher than the first authorization level, transferring the control right to the second controller, and executing at least one instruction corresponding to the second controller having the control right in the instruction queue first.

17. The managing method of render as claimed in claim 16, wherein the request information comprises a request information of control right and a request information of cleaning up instruction queue, wherein when the request information of cleaning up instruction queue is received, cleaning up all instructions corresponding to the first controller and transferring the control right to the second controller.

18. The managing method of render as claimed in claim 17, comprising:
when the request information of control right having a first code is received from the second controller, comparing whether the first code is identical to a preset second code; and
when the first code is identical to the preset second code, transferring the control right to the second controller.

19. A controller, comprising:
a generation unit, generating an instruction, wherein the instruction has a controller identification information of the controller; and
a request unit, connected to the generation unit, sending a request information to a render to request a control right of the render when the controller does not have the control right of the render, wherein the request information comprises the controller identification information.

20. The controller as claimed in claim 19, wherein the request unit sends a request information of cleaning up information queue so as to request for cleaning up all instructions corresponding to another controller having the control right in the instruction queue.

21. The controller as claimed in claim 19, wherein the request unit sends a request information having a first code, if the first code is identical to a preset second code of the render, the controller obtains the control right of the render.

22. A managing method of controller, adapted for a controller to control a render, comprising:
generating an instruction, wherein the instruction has a controller identification information of the controller; and
when the controller does not have a control right of the render, sending a request information to the render to request the control right of the render, wherein the request information comprises the controller identification information.

23. The managing method of controller as claimed in claim 22, wherein the step of sending the request information to the render comprises:
sending request information of cleaning up instruction queue so as to request for cleaning up all instructions corresponding to another controller having the control right in an instruction queue of the render.

24. The managing method of controller as claimed in claim 22, wherein the step of sending the request information to the render comprises:
sending a request information having a first code; and
when the first code is identical to a preset second code of the render, the controller obtains the control right of the render.
